(19) United States
(12) Patent Application Publication
(10) Pub. No.: US 2008/0090939 A1
(43) Pub. Date: Apr. 17, 2008

(54) BIODEGRADABLE SOY PROTEIN-BASED COMPOSITIONS AND COMPOSITES FORMED THEREFROM

(76) Inventors: Anil N. Netravali, Ithaca, NY (US); Xiaosong Huang, Ithaca, NY (US); Preeti Lodha, Mumbai (IN); Yuzo Yamamoto, Ithaca, NY (US)

Correspondence Address: JAECKLE FLEISCHMANN & MUGEL, LLP, 190 Linden Oaks, ROCHESTER, NY, 14625-2812, US

(21) Appl. No.: 11/867,959

(22) Filed: Oct. 5, 2007

Related U.S. Application Data
(63) Continuation-in-part of application No. 11/407,329, filed on Apr. 20, 2006.

(51) Int. Cl. C08H 1/00

(52) U.S. Cl. 523/124

(57) ABSTRACT

A biodegradable polymeric composition includes 99.5 wt. % to 40 wt. % soy protein and 0.5 wt. % to 60 wt. % of a first strengthening agent that consists essentially of a polysaccharide selected from the group consisting of agar, gellan, and mixtures thereof. The composition is substantially completely soluble in water at a pH of about 7.0 or higher. A biodegradable composite includes a fiber mat and the described biodegradable polymeric composition. A biodegradable molded thermoset solid article is obtained by subjecting the described biodegradable polymeric composition to conditions of temperature and pressure effective to form the thermoset solid article.

### CROSS-REFERENCE TO RELATED APPLICATION

This application is a continuation-in-part of co-pending application Ser. No. 11/407,329, CURED SOY PROTEIN WITH GREEN STRENGTHENING ADDITIVE AND FABRICATION OF SUCH INTO GREEN COMPOSITE, now published as Netravali et al., U.S. Patent Publ. Appl. No. 2006/0264135, the disclosure of which is incorporated herein by reference.

### FIELD OF THE INVENTION

The present invention relates to soy protein-based polymeric compositions and, more particularly, to biodegradable polymeric compositions containing soy protein in combination with polysaccharide strengthening agents.

### BACKGROUND OF THE INVENTION

Most commercial fibers and resins are derived from petroleum feedstock. However petroleum is not a replenishable commodity and at the current rate of consumption, it is expected to last another 50 years or so. By one estimate, the current consumption rate is about 100,000 times the rate at which the earth can generate it. As the supply of petroleum dwindles, its price will rise at an ever increasing rate.

It is also a matter of considerable concern that the majority of the composites and plastics produced from petroleum are non-degradable under normal environmental conditions. Those made using thermoset resins such as epoxies, polyurethanes, etc. are also impossible to recycle or reuse. While a very small fraction of these composites are crushed into powder and used as filler or incinerated to obtain heat value, most of them end up in landfills at the end of their life. Under the anaerobic conditions present in landfills, petroleum-based materials may persist without appreciable degradation in the landfill soil for decades if not centuries, making the land unusable. As an alternative to landfills, incinerators produce large amounts of toxic gases that require expensive scrubbers. Both land filling and incineration, besides being expensive, are environmentally undesirable.

Concerns about the environment, both with respect to pollution and sustainability, are rapidly rising. Extensive research efforts are being directed to develop environment-friendly and fully sustainable ‘green’ polymers, resins and composites that do not use petroleum as the feedstock but are based on sustainable sources such as plants. Such plant-based green materials can also be biodegradable and can thus be easily disposed of or composted at the end of their life without harming the environment. Fibers such as jute, flax, linen, hemp, bamboo, etc., which have been used for many centuries, are not only sustainable but also annually renewable. Because of their moderate mechanical properties, efforts are being directed toward their use in the reinforcement of plastics and the fabrication of composites for various applications. Such fibers may be used alone, as components of yarns, fabrics or non-woven mats, or various combinations thereof. Fully green composites fabricated using plant fibers such as jute, flax, linen, hemp, bamboo, kapok, etc., and resins such as modified starches and proteins have already been demonstrated and commercialized. High strength liquid crystalline (LC) cellulose fibers, prepared by spinning a solution of cellulose in phosphoric acid, can impart sufficiently high strength and stiffness to composites to make them useful for structural applications. However, since natural fibers are generally weak compared to high strength fibers such as graphite, aramid, etc., composites containing them typically have relatively poor mechanical properties, although they may be comparable to or better than wood. Thus, such composites are suitable for applications that do not require high mechanical performance, for example, packaging, product casings, housing and automotive panels, etc. Nonetheless these applications represent large markets, so increasing use of composites containing biodegradable natural materials should contribute substantially towards reducing petroleum-based plastic/polymer consumption.

The use of renewable materials from sustainable sources is increasing in a variety of applications. Biocomposites are materials that can be made in nature or produced synthetically, and include some type of naturally occurring material such as natural fibers in their structure. They may be formed through the combination of natural cellulose fibers with other resources such as biopolymers, resins, or binders based on renewable raw materials. Biocomposites can be used for a range of applications, for example: building materials, structural and automotive parts, absorbents, adhesives, bonding agents and degradable polymers. The increasing use of these materials serves to maintain a balance between ecology and economy. The properties of plant fibers can be modified through physical and chemical technologies to improve performance of the final biocomposite. Plant fibers with suitable properties for making biocomposites include, for example, hemp, kenaf, jute, flax, sisal, banana, pineapple, and kapok.

Biopolymers derived from various natural botanical resources such as protein and starch have been regarded as alternative materials to petroleum plastics because they are abundant, renewable and inexpensive. The widespread domestic cultivation of soybeans has led a great deal of research into the development of biopolymers derived from their byproducts. Soy protein is an important alternative to petroleum based plastic materials because it is abundant, renewable and inexpensive. Soy proteins, which are complex macromolecular polypeptides containing 20 different amino acids, can be converted into biodegradable plastics. However, soy protein plastics suffer the disadvantages of low strength and high moisture absorption. One of the simplest and most effective ways to improve these properties is to combine soy protein with a biodegradable polymer to form soy based bioplastic. Another approach is to use functional monomers or oligomers to modify soy protein during processing.

Fiber reinforced composites that include soy-based bioplastics are potentially useful for a variety of applications in the automotive, construction, furniture, and packaging industries. Natural fibers are attractive ingredients for reinforced composites because of their low cost, low density, acceptable specific strength properties, ease of separation, and biodegradability. In addition, agricultural plant materials such as corn stalk, rice stalk, wheat straw and grass have been investigated as a potentially useful natural fibers that are inexpensive, eco-friendly, sustainable, recyclable, and biodegradable.

Following is a compilation of prior art references, all incorporated herein by reference, that relate to biodegradable compositions and composites, including those containing soy protein:

Jane et al., U.S. Pat. No. 5,523,293, discloses a biodegradable soy protein thermoplastic composition that comprises the reaction mixture of soy protein, starch filler, plasticizer, reducing agent, and water.

Wang, U.S. Pat. No. 5,922,379, discloses a bidegradable protein/starch based thermoplastic composition comprising, protein, starch, natural cellulosic fiber, water, and a metallic salt hydrate, where the protein is a plant derived protein such as soybean protein.

Bassi et al., U.S. Pat. No. 5,665,152, discloses a method of forming a biodegradable article from a formulation comprising a grain protein, starch, plasticizer, and a reducing agent operable for cleaving disulfide bonds present in the grain protein, where the soy protein can be soy protein, wheat gluten, corn gluten and mixtures thereof, wheat gluten being preferred.

Shalaby et al., U.S. Pat. No. 6,306,997, discloses a modified soy protein composition comprising soy protein having substituted acylamido groups that include a carbon chain substituent selected from alkyl and alkenyl groups having at least eight carbon atoms in the chain.

Thames et al., U.S. Pat. No. 6,790,271, discloses a binder composition that comprises a soy protein, a plasticizer, and a vegetable oil derivative, preferably a maleinized vegetable oil, that has been altered to introduce at least one site suitable for reacting with protein nucleophiles and polyol plasticizers.

Thames et al., U.S. Pat. No. 7,081,159, discloses an adhesive formulation comprising a mixture of water, zinc sulfate, calcium oxide, sodium benzoate, pine oil, soy protein, wax emulsion, and non-sulfonated kraft lignin, as well as a particleboard that includes the formulation.

Li et al., U.S. Pat. No. 7,060,798, discloses an adhesive composition comprising a reaction product of soy protein and a compound that includes at least one first functional group selected from phenolic hydroxyl or thiol, and at least one amino functional group that binds to a carboxylic functional group of the soy protein.

Zhang et al., U.S. Pat. Nos. 6,632,925 and 6,806,353, disclose a biodegradable plant protein composite that comprises 5-90 parts by weight soy protein and 90-5 parts by weight of a polylactide, the total not exceeding 100 parts.

Kuo et al., U.S. Pat. Nos. 6,306,997 and 6,518,387, disclose soybean-based adhesive resins that comprise a soybean flour and a cross-linking agent, preferably a phenol-formaldehyde resin, that reacts with functional groups in the soybean flour to form the adhesive resins.

Damodaran, U.S. Pat. No. 6,821,331, discloses a protein-polysaccharide hydrogel comprising: an acylated crosslinked protein matrix, and an anionic polysaccharide matrix interpenetrating with the acylated crosslinked protein matrix; wherein the acylated crosslinked protein matrix may comprise soybean protein isolate, and the anionic polysaccharide may be selected from among alginates, carageenans, carboxylated starches, carboxyalkylcelluloses, gellans, hyaluronic acid, pectins, and xanthans.

Tokiwa et al., U.S. Pat. No. 6,987,138, discloses a biodegradable polylactide resin composition comprising (i) at least one protein selected from silk, gelatin, keratin, elastin, casein, gluten, zein and soybean protein, and (ii) degraded mannan.

Riebel et al., U.S. Pat. No. 5,635,123, discloses a biocomposite particulate material that comprises fiber-reinforced protein-based particles comprising an aqueous legume-based resin and fibrous cellulosic material, where the legume-based resin may include soy flour.

Sun et al., U.S. Pat. No. 6,337,097, discloses a biodegradable and edible composite formed from a mixture of adhesive and a fiber, where the fiber is derived from the group consisting of straw, corn stalks, sorghum stalks, soybean hulls, peanut hulls, fibers from grain milling by-products, and mixtures thereof.

Sun et al., U.S. Pat. No. 6,497,760, discloses a soy protein-based adhesive comprising soy protein isolate reacted in an aqueous system with guanidine hydrochloride.

Sun et al., U.S. Patent Appl. Publ. No 2005/0166796, discloses an adhesive composition comprising a protein portion, which may be corn protein, wheat protein, soy protein, and combinations thereof, an ingredient portion selected from the group consisting of carboxyl-containing compounds, aldehyde-containing compounds, epoxy group-containing compounds, and mixtures thereof; and a pH based on the isoelectric point of the protein.

Hse et al., U.S. Patent Appl. Publ. No 2005/0272892, discloses a water-resistant thermosetting adhesive resin comprising a phenol-activated hydrolyzate of soy reacted with an aldehyde.

Breyer et al., U.S. Patent Appl. Publ. Nos. 2005/0070635 and 2006/0234077, disclose wood composites bonded with an adhesive binder composition comprising a urea-formaldehyde resin and a soy protein or a modified soy protein.

Jong, U.S. Patent Appl. Publ. No. 2006/0094800, discloses (1) an ionic polymer, preferably containing carboxylic acid groups, sulfonic acid groups, or mixtures thereof, and (2) a protein and a carbohydrate-containing vegetable material, preferably selected from among soy spent flake, defatted soy flour, and soy protein concentrate.

Schilling et al., U.S. Patent Appl. Publ. No. 2004/0249065, discloses a method for producing biodegradable plastics by treating polysaccharide-containing or oligo-saccharide-containing materials with a basic aqueous solution, and subsequently treating the mixture with a modifying material to form an anionic product, which is allowed to react with a protein that may be a soy protein isolate.

Hiscock, U.S. Patent Appl. Publ. No. 2006/0194010, discloses a degradable packaging structure comprising a substrate layer, a resin layer, and a degradable tie layer between the substrate and resin layers, where the degradable tie layer may be a soy protein polymer material such as a soy protein isolate or soy protein concentrate.

Trocino, Sr., U.S. Patent Appl. Publ. No. 2003/0148084, discloses an adhesive comprising a copolymer of a vegetable protein, preferably soy protein or hydrolyzed soy protein, having a plurality of methylol groups and a comonomer having a plurality of methylol groups.

Wescott et al., U.S. Patent Appl. Publ. Nos. 2005/0222358 and 2005/0277733, disclose a method of preparing a protein-based adhesive by denaturing a protein that is preferably a soy-based protein, methylolating the denatured protein with a formaldehyde source, and copolymerizing the methylolated denatured protein with a copolymer to yield the adhesive, wherein the copolymer is selected from the group consisting of phenol, phenol formaldehyde, urea, urea formaldehyde, melamine, melamine formaldehyde, and mixtures thereof.

Wescott et al., U.S. Patent Appl. Publ. No. 2007/0148339, discloses a method of preparing a protein-based adhesive by denaturing a protein, preferably a soy-based protein, whereby a denatured protein in an adhesive state is obtained; and drying the protein, whereby the protein is in a powder form. Preferably, the denatured protein is cross-linked with either a formaldehyde-containing crosslinking agent or a formaldehyde-free crosslinking agent.

Li, U.S. Patent Appl. Publ. No. 2004/0089418, discloses a method for making a lignocellulosic composite that comprises binding lignocellulosic substrates to one another using a substantially formaldehyde-free adhesive that comprises the reaction product of a soy protein and a compound that is the adduct of an epoxy compound, specifically epichlorohydrin, with a polyamidoamine resin.

Drzal et al., U.S. Patent Appl. Publ. No. 2006/0043629, discloses a polymer composition that comprises thermoplastically processed plasticized soy flour comprising protein and carbohydrate and a thermoplastic polymer that is preferably an in situ-polymerized vinyl polymer such as polystyrene or poly(glycidyl methacrylate).

Rivers et al., U.S. Patent Appl. Publ. Nos. 2005/0261404 and 2006/0142433, disclose a thermosetting adhesive composition for use in particleboard or fiberboard that comprises a protein-based component, preferably soy protein, and a polymeric quaternary amine cure accelerant that is preferably a reaction product of a polyamidoamine and a halohydrin.

Taverne-Veldhuizen et al., International Publ. No. WO 00/06650, discloses a process for the manufacture of a composite material in which a material comprising a vegetable fiber, which may be obtained from soybean, is subjected to at least one pretreatment preferably selected from among heat treatment, size reduction, addition of alkali, mixing and/or blending, defibrillation, wetting or washing, and at least one thermoplastic processing step that may be effected within an extruder.

The following papers in the scientific literature also relate to soy protein-based resins and composites:

P. Lodha and A. N. Netravali, “Characterization of interfacial and mechanical properties of ‘green’ composites with soy protein isolate and ramie fiber,” J. Mat. Science, 2002, vol. 37, pp 3657-3665.

P. Lodha and A. N. Netravali, “Thermal and mechanical properties of environment-friendly ‘green’ plastics from stearic acid modified soy-protein isolate,” Industrial Crops and Products, 2005, vol. 21, pp 49-64.

P. Lodha and A. N. Netravali, “Characterization of stearic acid modified soy protein isolate resin and ramie fiber reinforced ‘green’ composites,” Composite Science and Technology, 2005, vol. 65, pp 1211-1225 (available online Feb. 8, 2005).

P. Lodha and A. N. Netravali, “Effect of soy protein isolate resin modifications on their biodegradation in a compost medium,” Polymer Degradation and Stability, 2005, vol. 87, pp 465-477 (available online Dec. 8, 2004).

P. Lodha and A. N. Netravali, “Characterization of Phytagel® Modified Soy Protein Isolate Resin and Unidirectional Flax Yarn Reinforced ‘Green’ Composites,” Polymer Composites, 2005, pp 647-659 (published online).

S. Chabba and A. N. Netravali, “‘Green’ composites Part 1: Characterization of flax fabric and glutaraldehyde modified soy protein concentrate composites,” J. Mat. Science, 2005 (published online Sep. 8, 2005).

S. Chabba and A. N. Netravali, “‘Green’ composites Part 2: Characterization of flax fabric and glutaraldehyde modified soy protein concentrate composites,” J. Mat. Science, 2005 (published online Sep. 8, 2005).

S. Chabba, G. F. Matthews, and A. N. Netravali, “‘Green’ composites using cross-linked soy flour and flax yarns,” Green Chemistry, 2005, vol. 7, pp 576-581 (published online as an Advance Article on May 20, 2005).

A. N. Netravali and S. Chabba, “Composites get greener,” Materials Today, April 2003.

X. Huang and A. N. Netravali, “Characterization of Nano-Clay Reinforced Phytagel-Modifies Soy Protein Concentrate Resin,” Biomacronmolecules, 2006, vol. 7, pp 2783-2789 (published online Sep. 2, 2006)

X. Huang and A. N. Netravali, “Characterization of flax fiber reinforced soy protein resin based green composites modified with nano-clay particles,” Composite Science and Technology, 2007, vol. 67, pp 2005-2014 (available online Jan. 30, 2007)

Y. Yamamoto, D. Zahora, and A. N. Netravali, “Determination of the interfacial properties between modified soy protein resin and kenaf fiber,” Composite Interfaces,” vol. 14, No. 7-9, pp 669-713 (2007).

C. H. Schilling, Mechanical properties of biodegradable soy-protein plastics,” J. Mater. Res., vol. 10, no. 9, September 1995, pp 2197-2202.

S. Wang, “Effects of Polyhydric Alcohols on the Mechanical Properties of Soy Protein Plastics,” J.M.S. —Pure Appl. Chem., 1996, A33(5), pp 557-569.

### SUMMARY OF THE INVENTION

The present invention is directed to a biodegradable polymeric composition comprising 99.5 wt. % to 40 wt. % soy protein and 0.5 wt. % to 60 wt. % of a first strengthening agent that consists essentially of a polysaccharide selected from the group consisting of agar, gellan, and mixtures thereof. The composition is substantially completely soluble in water at a pH of about 7.0 or higher.

The present invention is further directed to a biodegradable composite that includes a fiber mat and a biodegradable polymeric composition comprising 99.5 wt. % to 40 wt. % soy protein and 0.5 wt. % to 60 wt. % of a first strengthening agent that consists essentially of a polysaccharide selected from the group consisting of agar, gellan, and mixtures thereof. The polymeric composition is substantially completely soluble in water at a pH of about 7.0 or higher.

The present invention is also directed to a biodegradable molded thermoset solid article obtained by subjecting a biodegradable polymeric composition to conditions of temperature and pressure effective to form the thermoset solid article. The polymeric composition is substantially completely soluble in water at a pH of about 7.0 or higher and comprises 99.5 wt. % to 40 wt. % soy protein and 0.5 wt. % to 60 wt. % of a first strengthening agent that consists essentially of a polysaccharide selected from the group consisting of agar, gellan, and mixtures thereof.

The present invention is also directed to a curable biodegradable polymeric composition that is substantially free of starch and supplementary crosslinking agents and comprises 99.5 wt. % to 40 wt. % soy protein and 0.5 wt. % to 60 wt. % of a first strengthening agent consisting essentially of a polysaccharide selected from the group consisting of agar, gellan, and mixtures thereof. The composition can be subjected to curing conditions of temperature and pressure effective to form a thermoset pressure-shaped solid article.

The present invention is further directed to a method for preparing a biodegradable composite sheet that comprises the steps of: preparing an aqueous solution at a pH of about 7.0 or higher of a mixture comprising 99.5 wt. % to 40 wt. % soy protein and 0.5 wt. % to 60 wt. % of a first strengthening agent consisting essentially of a polysaccharide selected from the group consisting of agar, gellan, and mixtures thereof; coating and impregnating a fiber mat with the aqueous resin solution; heating the coated impregnated mat to a temperature effective to remove visible water, thereby forming an intermediate sheet; and subjecting the intermediate sheet to conditions of temperature and pressure effective to form a biodegradable composite sheet having a moisture content of less than about 1.0 wt. %.

### DETAILED DESCRIPTION OF THE INVENTION

In accordance with the present invention, a biodegradable polymeric composition comprises soy protein and a first strengthening agent that consists essentially of a polysaccharide selected from the group consisting of agar, gellan, and mixtures thereof. The composition is substantially completely soluble in water at a pH of about 7.0 or higher.

The biodegradable polymeric composition can be included in a biodegradable composite that further comprises second strengthening agent of natural origin that can be a particulate material, a fiber, or combinations thereof. The second strengthening agent may be, for example, a nanoclay, microfibrillated cellulose, nanofibrillated cellulose, a natural fiber selected from the group consisting of hemp, kenaf, jute, ramie, flax, linen, sisal, banana, pineapple, kapok, bamboo, ramie, cellulose, liquid crystalline (LC) cellulose, and combinations thereof.

In biodegradable composites of the present invention, the second strengthening agent may also be selected from the group consisting of a reinforcing fiber, a reinforcing filament, a reinforcing yarn, a woven fabric, a knitted fabric, a non-woven fabric, and combinations thereof. In a preferred embodiment, the second strengthening agent comprises a plurality of reinforcing fibers formed into a mat, a sheet, or combinations thereof. Fiber mats and/or sheets are combined with the biodegradable polymeric composition described above to form a biodegradable composite in accordance with the invention.

Preferably, the weight ratio of soy protein:first strengthening agent in the biodegradable polymeric composition of the present invention is about 20:1 to about 1:1. The composition may also include a plasticizer, the weight ratio of plasticizer:(soy protein+first strengthening agent) preferably being about 1:20 to about 1:4. In a preferred embodiment, the plasticizer comprises glycerol.

The biodegradable polymeric composition of the present invention preferably is substantially free of starch. Also, although many soy-based polymeric compositions of the prior art include supplementary crosslinking agents such as, for example, acid anhydrides, isocyanates, and epoxy compounds, compositions of the present invention are preferably substantially free of such supplementary crosslinking agents.

Also in accordance with the present invention, a biodegradable molded thermoset polymeric article is obtained by subjecting the biodegradable polymeric composition described above to conditions of temperature and pressure effective to form thermoset polymeric article. Effective temperature and pressure conditions preferably comprise a temperature of about 35° C. to about 130° C. and a pressure of about 0.1 MPa to about 20 MPa, more preferably, a temperature of about 80° C. to about 120° C. and a pressure of about 4 MPa to about 20 MPa.

In one preferred embodiment, the molded thermoset polymeric article comprises a thermoset sheet, which may be included in a stacked array of thermoset sheets. Alternatively, the biodegradable press-shaped thermoset polymeric article may be shaped by a mold.

Preferably, the biodegradable press-shaped thermoset polymeric article is characterized a stress at maximum load of at least about 20 MPa and/or a modulus of at least about 300 MPa.

Also in accordance with the present invention, a method for preparing a biodegradable composite sheet comprises the steps of: preparing an aqueous solution of the resin at a pH of about 7.0 or higher, of the mixture of soy protein and first strengthening agent, as described above; coating and impregnating a fiber mat with the aqueous solution; heating the coated impregnated mat to remove water, thereby forming a substantially dry intermediate sheet (also known as a “prepreg”); and subjecting the intermediate sheet to conditions of temperature and pressure effective to form a biodegradable composite sheet having a moisture content of less than about 0.5 wt. %. Effective temperature and pressure conditions preferably comprise a temperature of about 35° C. to about 130° C. and a pressure of about 0.1 MPa to about 20 MPa, more preferably, a temperature of about 80° C. to about 120° C. and a pressure of about 4 MPa to about 20 MPa.

A biodegradable composite article comprising a stacked array of biodegradable composite sheets is formed from a stack of intermediate sheets prepared as described above; and subjecting the stack of intermediate sheets to conditions of temperature and pressure effective to form a biodegradable composite article having a moisture content of less than about 1.0 wt. %. Effective temperature and pressure conditions preferably comprise a temperature of about 80° C. to about 120° C. and a pressure of about 4 MPa to about 20 MPa. Optionally a layer of the aqueous solution described above may be applied to at least one of the surfaces of the intermediate sheets prior to subjecting the stack to elevated temperature and pressure conditions.

Soy protein has been modified in various ways and used as resin in the past, as described in, for example, Netravali, A. N. and Chabba, S., Materials Today, pp. 22-29, April 2003; Lodha, P. and Netravali, A. N., Indus. Crops and Prod. 2005, 21, 49; Chabba, S. and Netravali, A. N., J. Mater. Sci. 2005, 40, 6263; Chabba, S. and Netravali, A. N., J. Mater. Sci. 2005, 40, 6275; and Huang, X. and Netravali, A. N., Biomacromolecules, 2006, 7, 2783.

Soy protein contains about 20 different amino acids, including those that contain reactive groups such as —COOH, —NH₂ and —OH groups. Once processed, soy protein itself can form crosslinks through the —SH groups present in the cysteine amino acid as well as through the dehydroalanine (DHA) residues formed from alanine by the loss of side chain beyond the β-carbon atom. DHA is capable of reacting with lysine and cysteine by forming lysinoalanine and lanthionine crosslinks, respectively. Asparagines and lysine can also react together to form amide type linkages. All these reactions can occur at higher temperatures and under pressure that is employed during curing of the soy protein. However, the crosslinked soy protein is very brittle and has low strength.

In addition to the self-crosslinking in soy protein, the reactive groups can be utilized to modify soy proteins further to obtain desired mechanical and physical properties. The most common soy protein modifications include: addition of crosslinking agents and internal plasticizers, blending with other resins, and forming interpenetrating networks (IPN) with other crosslinked systems. These modifications are intended to improve the mechanical and physical properties of the soy resin. The properties of the soy resins can be further improved by adding nanoclay particles and micro- and nano-fibrillar cellulose (MFC, NFC), as described in, for example, Huang, X. and Netravali, A. N., “Characterization of flax yarn and flax fabric reinforced nano-clay modified soy protein resin composites,” Compos. Sci. and Technol., in press, 2007; and Netravali, A. N.; Huang, X.; and Mizuta, K., “Advanced green Composites,” Advanced Composite Materials, submitted, 2007.

Gellan, a linear tetrasaccharide that contains glucuronic acid, glucose and rhamnose units, is known to form gels through ionic crosslinks at its glucuronic acid sites, using divalent cations naturally present in most plant tissue and culture media. In the absence of divalent cations, higher concentration of gellan is also known to form strong gels via hydrogen bonding. The mixing of gellan with soy protein isolate has been shown to result in improved mechanical properties. See, for example, Huang, X. and Netravali, A. N., Biomacromolecules, 2006, 7, 2783 and Lodha, P. and Netravali, A. N., Polymer Composites, 2005, 26, 647.

Gellan gum is commercially available as Phytagel™ from Sigma-Aldrich Biotechnology. It is produced by bacterial fermentation and is composed of glucuronic acid, rhanmose and glucose, and is commonly used as a gelling agent for electrophoresis. Based on its chemistry, cured Phytagel™ is fully degradable. In preparing a composition of the present invention wherein cured gellan gum is the sole strengthening agent, Phytagel™ is dissolved in water to form a solution or weak gel, depending on the concentration. The resulting solution or gel is added to the initial soy protein powder suspension, with or without a plasticizer such as glycerol, under conditions effective to cause dissolution of all ingredients and produce a homogeneous composition.

The term “biodegradable” is used herein to mean degradable over time by water and/or enzymes found in nature, without harming the environment.

The terms “biodegradable resin” and “biodegradable composite” are used herein to mean that the resin and composite are sustainable and at the end of their useful life, can be disposed of or composted without handing the environment.

The term “stress at maximum load” means the stress at load just prior to fracture, as determined by the stress-strain curve in a tensile test.

The term “fracture stress” means the stress at fracture as determined by the stress-strain curve in a tensile test.

The term “fracture strain” means the strain (displacement) at fracture, as determined by the stress-strain curve in a tensile test.

The term “modulus” means stiffness, as determined by the initial slope of the stress-strain curve in a tensile test.

The term “toughness” means the amount of energy used in fracturing the material, as determined by the area under the stress-strain curve.

The tensile test referred to is carried out using Instron or similar testing device according to the procedure of ASTM Test No. D882 for resin sheets and D3039 for composites. Testing is carried out after 3 days conditioning at 21° C. and 65% R.H.

The term “strengthening agent” is used herein to describe a material whose inclusion in the biodegradable polymeric composition of the present invention results in an improvement in any of the characteristics “stress at maximum load”, “fracture stress”, “fracture strain”, “modulus”, and “toughness” measured for a solid article formed by curing of the composition, compared with the corresponding characteristic measured for a cured solid article obtained from a similar composition lacking the strengthening agent.

As already noted, the substantially water-soluble composition of the present invention includes a first strengthening agent that consists essentially of a polysaccharide selected from the group consisting of agar, gellan, and mixtures thereof. Inclusion of a second strengthening agent of natural origin selected from the group consisting of a particulate material, a fiber, and combinations thereof, typically results in an improvement in one or more of the above recited characteristics of the solid article obtained by curing.

The term “curing” is used herein to describe subjecting the composition of the present invention to conditions of temperature and effective to form a solid article having a moisture content of preferably less than about 0.5 wt. %.

A biodegradable composite solid article in accordance with the present invention may be prepared by the following illustrative procedure:

Into a mixing vessel at a temperature of about 70-85° C. is added 50-150 parts water, 1 part glycerol, 10 parts soy protein concentrate or isolate, and 1-3 parts gellan or agar. To the mixture is added, with vigorous stirring, a sufficient amount of aqueous sodium hydroxide to bring the pH of the mixture to about 11. The resulting mixture is stirred for 10-30 minutes, then filtered to remove any residual particles. Optionally, clay nanoparticles and/or cellulose nanofibers may be added to the resin solution as additional strengthening agents.

The resin solution so produced is used to impregnate and coat one or more fiber mats or fabric sheets. The mats may comprise, for example, kenaf or hemp fiber; fabric sheets may comprise, for example, flax.

Resin solution is applied to a fiber mat or sheet in an amount of about 50-100 ml of resin solution per 15 grams of fiber so as to thoroughly impregnate the mat or sheet and coat its surfaces. The mat or sheet so treated is pre-cured by drying in an oven at a temperature of about 35-70° C. to form what is referred to as a prepreg.

To form an article comprising a plurality of prepregs, two or three pre-cured mats are coated on each surface with additional resin solution in a stack. If desired, fabric prepregs may be interspersed between the fiber mats. The stack is hot pressed for 2-10 minutes at about 80° C. and a load of 0.5-1 MPa. Following a rest period of about 5 minutes, the stack is hot pressed for 5-15 minutes at 120-130° C. and a load of 2-10 MPa, followed by removal from the press. The resulting solid article exhibits excellent tensile properties.

A biodegradable composite article of the present invention may comprise a thermoset composite sheet in the form of a flat sheet, as just described. Alternatively, the thermoset sheet may be corrugated, with a lateral profile comprising alternating ridges and valleys.

The corrugated sheet may be formed using a conventional thermoforming molding process, using apparatus described in U.S. patents classified in class 425, subclasses 369 (apparatus wherein reshaping means creates accordion-like pleats or wrinkles or the like in a preform by distorting a section thereof transverse to its axis into a plurality of reversing curves) and 336 (apparatus comprising means for shaping an advancing length of work into ridges and grooves).

Also envisioned in accordance with the present invention are biodegradable composite solid articles that comprise a stacked array of biodegradable composite sheets containing both flat and corrugated sheets. For example, the array could include a middle corrugated sheet disposed between and adhered to two flat sheets, providing bending stiffness in the direction of the corrugations. In another configuration, two superimposed corrugated sheets whose corrugations are orthogonal to one another are secured between two flat outer sheets, resulting in a structure of enhanced stiffness in both directions.

Further in accordance with the present invention, a composition containing gellan and soy protein can be employed together with natural and high strength liquid crystalline (LC) cellulosic fibers to form biodegradable composites. The LC cellulose fibers can be produced by dissolving cellulose in highly concentrated phosphoric acid to form a LC solution of cellulose, as described in Borstoel, H., “Liquid crystalline solutions of cellulose in phosphoric acid,” Ph. D. Thesis, Rijksuniversiteit, Groningen, Netherlands, (1998). The resulting LC solution was spun using an air gap-wet spinning technique to obtain highly oriented and crystalline cellulose fibers that had strengths in the range of 1700 MPa.

Materials. Soy protein concentrate (SPC) powder, which contains substantially no starch, was obtained from Archer Daniels Midland Co., Decatur, Ill. Analytical grade gellan was obtained from Sigma-Aldrich Co. St Louis, Mo. Analytical grade glycerol was obtained from Fisher Scientific, Pittsburgh, Pa. Both chemicals were used as received. Montmorillonite (MMT) clay was obtained from Southern Clay Products, Inc., TX., under the brand name of Cloisite Na⁺. The LC cellulose fibers were provided by Dr. H. Borstoel.

Resin Processing. To form nanoclay reinforced SPC resin, clay particles were first dispersed in distilled and deionized (DI) water using stirring and ultrasonication to obtain an exfoliated clay slurry. The slurry was stabilized for 1 week before removing the nonexfoliated and larger aggregates that had settled out. Freeze drying was employed to isolate the purified nanoclay powder from the stabilized slurry. The purified clay powder was dispersed into DI water in a weight ratio of 1:100 to form a stable yellowish slurry containing the nanoclay particles.

The SPC powder and gellan were first dispersed into DI water separately in a ratio of 1:15 by weight; ratios of about 1:4 to about 1:20 are suitable. A magnetic stirrer is employed to produce a uniform mixture, which was pre-cured at 75° C. for 25 min. Various amounts of dispersed clay slurry were directly introduced into the precuring mixture. The mixture was then stirred for another 5 min to complete the pre-curing. The pre-cured solution was cast into sheets, dried and hot pressed (cured) on a Carver hydraulic hot press (model 3891-4PROA00) for 25 min at 120° C. under a pressure of 7 MPa.

Biodegradable Composites. To fabricate unidirectional composites using LC cellulose fibers, the fiber tows were wound onto a metal frame and soaked in the pre-cured resin solutions. The soaking of the LC cellulose fibers was done in such a way that full impregnation of the resin was obtained. After soaking, the parallel fiber arrays were dried in an air circulating oven at 35° C. for 24 h. Two resin compositions were used, the numbers in parentheses being relative weights based on an SPC weight of 100:

| | |
|---|---|
| 1) SP-GN | SPC (100) + Gellan (50) + Glycerol (8) |
| 2) SP-GN-C | SPC (100) + Gellan (50) + Glycerol (15) + Nanoclay (7) |

The dried composite specimens were fabricated by placing the dried, resin-coated fiber arrays in several layers and cured by hot pressing at 120° C. under a pressure of 8 MPa for 20 min. The composite thicknesses ranged between 0.12 to 0.15 mm. All composites had a 40±2% fiber volume fraction.

Characterization. The resin tensile properties were characterized after conditioning for 3 days at 21° C. and 65% relative humidity (RH) using the Instron universal testing machine (Model 5566). The gauge length and strain rate were 50 mm and 1 min−1. The composite specimens were tension tested using the same Instron universal testing machine after conditioning for 5 days at 21° C. and 65% RH. The gauge length and strain rate were 50 mm and 1 min⁻¹. The flexural properties of the composites were characterized by a three point bending test using the same Instron machine. The specimen span length was 25 mm and the crosshead speed was 0.16 mm/min.

Results and Discussion

Resins. TABLE 1 shows the effect of gellan content on the SPC resin (SPC-GN) properties. As can be seen from the data, as the amount of gellan was increased from 0 to 50 parts based on SPC content, the resin stiffness (Young's modulus) and fracture stress increased from 201 to 742 MPa and from 14.7 to 52.4 MPa, respectively. At the same time, the fracture strain decreased from over 25% to about 14%. Although the moisture content (MC %) of the resins is not shown in TABLE 1 below, the MC % was reduced from 16.7% to 15.5% as the gellan content increased from 0% to 50%. Also when the SPC-GN was dried, a significant shrinkage was observed when compared to SPC alone. The toughness of the SPC-GN resins also increased as the gellan content increased, indicating that the gellan network is flexible. Glass transition studies using dynamic mechanical analysis did not show any phase separation.

TABLE 1
Effect of Gellan on Tensile Properties of SPC-GN Resin*

| Gellan content | Fracture stress | Fracture strain | Modulus |
|---|---|---|---|
| (%) | (MPa) | (%) | (MPa) |
| 0 | 14.7 (6.6)** | 25.7 (6.0) | 201 (5.5) |
| 10 | 26.1 (12.5) | 18.8 (3.2) | 406 (6.5) |
| 20 | 34.9 (4.6) | 17.1 (5.2) | 538 (6.1) |
| 40 | 50.1 (5.5) | 14.8 (4.2) | 717 (4.6) |
| 50 | 52.4 (3.1) | 14.2 (4.3) | 742 (4.5) |

*Resins contain 20% glycerol as plasticizer
**Figures in parentheses are CV %

TABLE 2 presents the effect of nanoclay loading on the tensile properties of the SPC-GN resins. These clay-loaded resins, referred to as SPC-GN-C, contained 40 parts of gellan for 100 parts of SPC and were processed at neutral pH. Both X-ray diffraction and TEM studies showed excellent dispersion of the nanoclay particles. Clay particles are negatively charged and at neutral pH, the SPC is also negatively charged. In addition, both resins and nanoparticles being hydrophilic, nanoclay clustering that is seen in many other polymers was not seen in this case. Exfoliated nanoclay particles are like sheets with thickness of about 1 nm and the two other dimensions of several hundred nanometers. The uniform dispersion and the sheet like structure of the nanoclay results in the high tortuosity for the polymeric molecules and results in higher mechanical properties. For 10% nanoclay loading, the modulus was 2.3 GPa and the fracture stress was 71 MPa. The fracture stress remained constant because of the reduced fracture strain. Similar results have been observed in many petroleum derived polymers such as polyesters, polypropylene, and nylons by several researchers. See, for example, Fornes, T. D., and Paul, D. R., Macromolecules, 2004, 37, 7698; Lee, K. M. and Han, C. D.; Macromolecules, 2003, 36, 804.

TABLE 2
Effect of Nanoclay Loading on SPC-GN Resins*

| Clay | Fracture stress | Fracture strain | Modulus | Moisture content |
|---|---|---|---|---|
| (%) | (MPa) | (%) | (MPa) | (%) |
| 0 | 66.2 (4.5)** | 10.0 (7.4) | 1675 (2.4) | 14.4 |
| 5 | 70.6 (3.2) | 9.8 (3.8) | 1983 (5.7) | 14.4 |
| 7 | 74.5 (0.9) | 9.5 (6.7) | 2124 (2.1) | 14.1 |
| 10 | 71.4 (5.7) | 8.6 (8.1) | 2302 (2.2) | 13.9 |

*Resins contain 12.5% glycerol as plasticizer
**Figures in parentheses are CV %

These mechanical properties are comparable to many commonly used DGEBA based epoxy resins, showing that it is possible to obtain sustainable resins that are derived from plants.

Composites. As stated above, two different resins based on SPC were used to fabricate the high strength green composites. The first resin was formed from SPC and gellan (SPC-GN), and the second resin included dispersed nanoclay particles (SPC-GNC). The fiber/resin interfacial shear strengths were measured for the two resins, using a microbead technique, and found to be in the range of 12 MPa. This indicates good interaction between the fiber and the resin, both of which contain hydrogen bond-promoting polar groups such as —OH, —NH₂ and —COOH.

The LC cellulose fibers employed in this study had a density of 1.52 g/cc and were further characterized by a fracture stress of 1680 MPa, fracture strain of 11.46%, and Young's modulus of 39.9 GPa.

Tensile properties of the unidirectional green composites for both #1 and #2 resins are presented in TABLE 3. It is clear that these composites have excellent strength and modulus and both composites have comparable properties reflecting the fiber properties. Also, since the fracture strains are significantly larger than the commonly used high strength composites made using glass or Kevlar® fibers, these are also significantly tougher than glass and Kevlar® based composites. See Netravali, A. N.; Huang, X.; and Mizuta, K., “Advanced green Composites,” Advanced Composite Materials, submitted, 2007. Increasing the fiber volume to 60% would be expected to further increase the strength of the composites.

TABLE 3
Tensile Properties of High Strength
LC Cellulose-Containing Composites

| | Fracture stress | Fracture strain | Young's modulus |
|---|---|---|---|
| Resin | (MPa) | (%) | (GPa) |
| 1) SP-GN | 565 (4.8)* | 9.59 (6.5) | 13.1 (5.2) |
| 2) SP-GN-C | 638 (5.5) | 10.07 (5.9) | 12.5 (6.1) |

*Figures in parentheses are CV %

The flexural properties of the high strength green composites are presented in TABLE 4. These are also comparable to glass and Kevlar® based composites. SEM photomicrographs of the fracture surfaces confirmed the excellent fiber/resin interaction. The composite properties suggest that these composites may be used for structural applications. However, since both resins and fibers are polar and absorb a significant amount of water, these green composites and resins are not suitable for outdoor applications. With moisture absorption, these composites may swell and warp. Also, their mechanical properties will decrease as they absorb moisture.

TABLE 4
Flexural Properties of High Strength
LC Cellulose-Containing Composites

| | Flexural stress | Flexural strain | Flexural modulus |
|---|---|---|---|
| Resin | (MPa) | (%) | (GPa) |
| 1) SP-GN | 228 (5.1)* | 2.08 (7.1) | 24.3 (5.7) |
| 2) SP-GN-C | 248 (8.7) | 2.03 (9.2) | 27.8 (5.9) |

*Figures in parentheses are CV %

### CONCLUSIONS

The tensile properties of the SPC resin increased significantly with the addition of gellan. The tensile properties of the SPC-GN resins increased further when nanoclay particles were dispersed. SPC and gellan are easily blended, and the nanoclay particles are readily dispersed in the SPC-GN resin.

The fiber/resin interaction was excellent. The high strength green composites formed using LC cellulose fibers had excellent tensile and flexural properties. These green composites also show excellent toughness. These composites may be used for structural applications. However, the moisture absorption of these composites is significant. As a result, these composites may only be suitable for indoor applications. These high strength green composites can be easily disposed of or composted at the end of their life. Since they are derived from plant sources, they are fully sustainable.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed:

1. A biodegradable polymeric composition comprising 99.5 wt. % to 40 wt. % soy protein and 0.5 wt. % to 60 wt. % of a first strengthening agent consisting essentially of a polysaccharide selected from the group consisting of agar, gellan, and mixtures thereof, said composition being substantially completely soluble in water at a pH of about 7.0 or higher.

2. A biodegradable composite comprising the polymeric composition of claim 1, and further comprising a second strengthening agent of natural origin selected from the group consisting of a particulate material, a fiber, and combinations thereof.

3. The biodegradable composite of claim 2 wherein said second strengthening agent comprises a nanoclay.

4. The biodegradable composite of claim 2 wherein said second strengthening agent comprises microfibrillated cellulose.

5. The biodegradable composite of claim 2 wherein said second strengthening agent comprises nanofibrillated cellulose.

6. The biodegradable composite of claim 2 wherein said second strengthening agent comprises liquid crystalline (LC) cellulose.

7. The biodegradable composite of claim 2 wherein said fiber is selected from the group consisting of hemp, kenaf, jute, flax, linen, sisal, banana, pineapple, kapok, bamboo, ramie, cellulose, and combinations thereof.

8. The biodegradable composite of claim 2 wherein said second strengthening agent is selected from the group consisting of a reinforcing fiber, a reinforcing filament, a reinforcing yarn, a woven fabric, a knitted fabric, a non-woven fabric, and combinations thereof.

9. The biodegradable composite of claim 2 wherein said second strengthening agent comprises a plurality of reinforcing fibers formed into a mat.

10. The biodegradable polymeric composition of claim 1 wherein the weight ratio of soy protein:first strengthening agent is about 20:1 to about 1:1.

11. The biodegradable polymeric composition of claim 1 further comprising a plasticizer.

12. The biodegradable polymeric composition of claim 11 wherein the weight ratio of plasticizer:(soy protein+first strengthening agent) is about 1:20 to about 1:4.

13. The biodegradable polymeric composition of claim 11 wherein said plasticizer comprises glycerol.

14. The biodegradable polymeric composition of claim 1 substantially free of starch.

15. The biodegradable polymeric composition of claim 1 substantially free of supplementary crosslinking agents.

16. A curable biodegradable polymeric composition comprising 99.5 wt. % to 40 wt. % soy protein and 0.5 wt. % to 60 wt. % of a first strengthening agent consisting essentially of a polysaccharide selected from the group consisting of agar, gellan, and mixtures thereof, said composition being substantially free of starch and supplementary crosslinking agents.

17. A biodegradable composite comprising the polymeric composition of claim 16, and further comprising: a second strengthening agent of natural origin selected from the group consisting of a particulate material, a fiber, and combinations thereof.

18. A molded thermoset solid article formed from the composition of claim 16, said composition being subjected to curing conditions of temperature and pressure effective to form said thermoset solid article.

19. The molded thermoset solid article of claim 18 comprising a sheet or a molded article.

20. A biodegradable composite comprising a fiber mat and a biodegradable polymeric composition comprising 99.5 wt. % to 40 wt. % soy protein and 0.5 wt. % to 60 wt. % of a first strengthening agent consisting essentially of a polysaccharide selected from the group consisting of agar, gellan, and mixtures thereof, said composition being substantially completely soluble in water at a pH of about 7.0 or higher.

21. A biodegradable molded thermoset solid article obtained by subjecting a biodegradable polymeric composition to conditions of temperature and pressure effective to form said thermoset solid article, said composition comprising 99.5 wt. % to 40 wt. % soy protein and 0.5 wt. % to 60 wt. % of a first strengthening agent consisting essentially of a polysaccharide selected from the group consisting of agar, gellan, and mixtures thereof, said composition being substantially completely soluble in water at a pH of about 7.0 or higher.

22. The biodegradable molded thermoset solid article of claim 21 wherein said conditions of temperature and pressure effective to form said thermoset solid article comprise a temperature of about 35° C. to about 130° C. and a pressure of about 0.1 MPa to about 20 MPa.

23. The biodegradable molded thermoset solid article of claim 22 wherein said conditions of temperature and pressure effective to form said thermoset solid article comprise a temperature of about 80° C. to about 120° C. and a pressure of about 4 MPa to about 20 MPa.

24. The biodegradable molded thermoset solid article of claim 21 comprising a thermoset sheet.

25. The biodegradable molded thermoset solid article of claim 21 comprising a stacked array of thermoset sheets.

26. The biodegradable molded thermoset solid article of claim 21 shaped by a mold.

27. The biodegradable molded thermoset solid article of claim 21 having a stress at maximum load of at least about 20 MPa.

28. The biodegradable molded thermoset solid article of claim 21 having a modulus of at least about 300 MPa.

29. A method for preparing a biodegradable composite sheet comprising the steps of:
preparing an aqueous resin solution at a pH of about 7.0 or higher of a mixture comprising 99.5 wt. % to 40 wt. % soy protein and 0.5 wt. % to 60 wt. % of a first strengthening agent consisting essentially of a polysaccharide selected from the group consisting of agar, gellan, and mixtures thereof;
coating and impregnating a fiber mat with said aqueous solution;
heating said coated impregnated mat to a temperature effective to remove water, thereby forming a substantially dry intermediate sheet; and
subjecting said intermediate sheet to conditions of temperature and pressure effective to form a biodegradable composite sheet having a moisture content of less than about 0.5 wt. %.

30. The method for preparing a biodegradable composite sheet of claim 29 wherein said conditions of temperature and pressure effective for preparing said biodegradable composite sheet comprise a temperature of about 35° C. to about 130° C. and a pressure of about 0.1 MPa to about 20 MPa.

31. The method for preparing a biodegradable composite sheet of claim 30 wherein said conditions of temperature and pressure effective for preparing said biodegradable composite sheet comprise a temperature of about 80° C. to about 120° C. and a pressure of about 4 MPa to about 20 MPa.

32. A method for preparing a biodegradable composite solid article comprising a stacked array of biodegradable sheets, said process comprising:
forming a stack of intermediate sheets produced by the method of claim 29;
optionally applying a layer of the aqueous resin solution of claim 28 to at least one of the surfaces of said intermediate sheets; and
subjecting said stack of intermediate sheets to conditions of temperature and pressure effective to form a biodegradable composite solid article having a moisture content of less than about 0.5 wt. %.

33. The method for preparing a biodegradable composite solid article of claim 32 wherein said conditions of temperature and pressure effective to form said biodegradable composite article comprise a temperature of about 35° C. to about 130° C. and a pressure of about 0.1 MPa to about 20 MPa.

34. The method for preparing a biodegradable composite solid article of claim 32 wherein said conditions of temperature and pressure effective to form said biodegradable composite article comprise a temperature of about 80° C. to about 120° C. and a pressure of about 4 MPa to about 20 MPa.

35. The method of claim 32 wherein said stacked array of biodegradable composite sheets further comprises at least one fabric sheet in contact with at least one of said intermediate sheets.

36. The method for preparing a biodegradable composite sheet of claim 29 wherein said composite sheet is a flat sheet.

37. The method for preparing a biodegradable composite sheet of claim 29 wherein said composite sheet is a corrugated sheet.

38. The biodegradable molded thermoset solid article of claim 25 comprising a stacked array of thermoset sheets, said array comprising at least one flat sheet and at least one corrugated sheet.
